(19) United States
(12) Patent Application Publication
(10) Pub. No.: US 2018/0287282 A1
(43) Pub. Date: Oct. 4, 2018

(54) CONNECTOR AND CONNECTOR SYSTEM

(71) Applicant: KYOCERA CORPORATION, Kyoto (JP)

(72) Inventors: Shintaro HORINO, Santa Clara, CA (US); Akio TSUNEMURA, Machida-shi (JP)

(21) Appl. No.: 15/767,621

(22) PCT Filed: Jul. 5, 2016
(86) PCT No.: PCT/JP2016/003206

§ 371 Date: Apr. 11, 2018

(30) Foreign Application Priority Data
Oct. 14, 2015 (JP) 2015-202658

(51) Int. Cl. H01R 12/73; H01R 12/71; H01R 13/11; H01R 12/00

(52) U.S. Cl. CPC H01R 12/73; H01R 12/716; H01R 12/57; H01R 9/091; H01R 13/11

(57) ABSTRACT

Provided are a connector and connector system that achieve stable grounding capability, signaling capability, power supply capability, and the like, and that are highly robust and have excellent workability while responding to the demand for size reduction. A connector includes a solid insulator (30) and one or two conducting members (40) covering a portion of the surface of the solid insulator (30). The solid insulator (30) and the conducting members (40) cooperate with each other to form a fitting projection that fits into a fitting recess of a counterpart connector (50).

### CROSS-REFERENCE TO RELATED APPLICATION

The present application claims priority to and the benefit of Japanese Patent Application No. 2015-202658 filed Oct. 14, 2015, the entire contents of which are incorporated herein by reference.

### TECHNICAL FIELD

The present disclosure relates to a connector and a connector system for board connection, for example a connector and connector system with few poles applied to connection of a board inside a smartphone with a ground, signal, or power source of a module.

### BACKGROUND

A known connector and connector system for a board connection are basically configured to have a plug connector and a receptacle connector. The plug connector includes a plug insulator in which a multi-pole plug contact is housed (embedded), and the receptacle connector includes a receptacle insulator in which a multi-pole receptacle contact is housed (embedded). For grounding or a power source, for example, metal fittings provided at the ends of multi-pole board-to-board connectors are placed in contact (connected) to become conductive.

Upon fitting the plug connector into the receptacle connector, the multi-pole plug contact and the multi-pole receptacle contact become conductive, and a signal line is formed, allowing transmission of electric signals between the boards connected to the connectors. At the same time, the metal fittings provided at the ends of the board-to-board connectors are placed in contact (connected) to achieve the function of grounding, a power source, or the like.

### CITATION LIST

### Patent Literature

PTL 1: JP 2014-38768 A

PTL 2: JP 5250450 B2

### SUMMARY

### Technical Problem

In mobile devices such as smartphones, the effect of transmission characteristics has grown with an increase in performance of the module, antenna, or the like. Therefore, a stable grounding capability, signaling capability, power supply capability, and the like are required to prevent malfunction.

In the above-described known connector and connector system, however, multi-pole contacts need to be connected within the connectors, and the metal fittings at the ends also need to be placed in contact (connected). Consequently, the insulator needs to be provided with an irregular shape that allows fitting, a recess in which the multi-pole contact is disposed, and a space such as a through-hole or groove. The shape of the metal fittings at the ends also becomes complex due to constraints for fitting and the like. The ends of the insulator, to which the metal fittings are attached, thus also tend to have a complex shape. As a result, coupled with the shape of the insulator, the impedance of the metal fitting portion increases, making it difficult to obtain a stable grounding capability, signaling capability, power supply capability, and the like.

Furthermore, an increased number of poles in the contact harbors a difficulty in improving the robustness for reasons such as breaking during the fitting operation. Commercial demand exists for a connector and connector system that are compact and have excellent workability and a high holding force upon fitting.

The present disclosure is based on an awareness of the above problems and aims to provide a connector and connector system that can achieve a stable grounding capability, signaling capability, power supply capability, and the like, and that are highly robust and have excellent workability while responding to the demand for size reduction.

### Solution to Problem

A connector of the present disclosure comprises a solid insulator; and one or two conducting members covering a portion of a surface of the solid insulator; wherein the solid insulator and the conducting members cooperate with each other to form a fitting projection that fits into a fitting recess of a counterpart connector.

The fitting projection may comprise a substantially flat portion facing a bottom of the fitting recess.

The solid insulator may comprise an intermediate flat portion positioned in an intermediate portion in a longitudinal direction; the conducting members may comprise bilateral flat portions positioned so as to sandwich the intermediate flat portion from both sides in the longitudinal direction; and the intermediate flat portion and the bilateral flat portions may form the substantially flat portion of the fitting projection.

The bottom of the fitting recess may be formed by a substantially flat portion that faces the substantially flat portion of the fitting projection with a slight clearance.

The counterpart connector may comprise a counterpart conducting member facing an inside surface of the fitting recess, and the conducting members forming the fitting projection may be configured to face the inside surface of the fitting recess and to engage with the counterpart conducting member.

The solid insulator and the connector comprising the conducting members may have a substantially rectangular parallelepiped shape, the conducting members may comprise opposing side covering portions covering opposing sides of the solid insulator that are separated in a longitudinal direction of the substantially rectangular parallelepiped shape, and the solid insulator may be configured not to have a gap between the opposing side covering portions of the conducting members.

A connector system of the present disclosure comprises a plug connector and a receptacle connector used by being assembled together, wherein the plug connector comprises a solid insulator and one or two conducting members covering a portion of a surface of the solid insulator; and the solid insulator and the conducting members cooperate with each other to form a fitting projection that fits into a fitting recess of the receptacle connector.

In the present disclosure, “solid” in the “solid insulator” refers to no multi-pole contact being located inside the insulator, i.e. to no groove, recess, or the like for housing (embedding) the multi-pole contact being formed. Consequently, the insulator is still considered a “solid insulator” if a minute groove, recess, or the like not for housing (embedding) a multi-pole contact is formed in the insulator.

### Advantageous Effect

The present disclosure provides a connector and connector system that can achieve a stable grounding capability, signaling capability, power supply capability, and the like, and that are highly robust and have excellent workability while responding to the demand for size reduction.

### BRIEF DESCRIPTION OF THE DRAWINGS

In the accompanying drawings:

FIG. 1 is a perspective view, from the fitting side, of a plug connector in which a plug insulator and plug-side conducting members are coupled;

FIG. 2 is a perspective view, from the opposite side from the fitting side, of the plug connector in which the plug insulator and the plug-side conducting members are coupled;

FIG. 3 is a perspective view, from the fitting side, of the plug connector in which the plug insulator and the plug-side conducting members are separated;

FIG. 4 is a perspective view, from the opposite side from the fitting side, of the plug connector in which the plug insulator and the plug-side conducting members are separated;

FIG. 5 is a perspective view, from the fitting side, of a receptacle connector in which a receptacle insulator and receptacle-side conducting members are coupled;

FIG. 6 is a perspective view, from the opposite side from the fitting side, of the receptacle connector in which the receptacle insulator and the receptacle-side conducting members are coupled;

FIG. 7 is a perspective view, from the fitting side, of the receptacle connector in which the receptacle insulator and the receptacle-side conducting members are separated;

FIG. 8 is a perspective view, from the opposite side from the fitting side, of the receptacle connector in which the receptacle insulator and the receptacle-side conducting members are separated;

FIG. 9 is a perspective view illustrating the plug connector and the receptacle connector in a fitted state;

FIG. 10 is a perspective view illustrating the plug connector and the receptacle connector in a separated state;

FIG. 11 is a plan view illustrating the plug connector and the receptacle connector in a fitted state;

FIG. 12 is a cross-section in the direction of the arrows along the XII-XII line in FIG. 11;

FIG. 13 is a cross-section in the direction of the arrows along the XIII-XIII line in FIG. 11;

FIG. 14 is a cross-section in the direction of the arrows along the XIV-XIV line in FIG. 11;

FIG. 15 is a perspective view corresponding to FIG. 1, illustrating a modification to the plug connector in which the two plug-side conducting members (two pins) are replaced by one (one pin); and

FIG. 16 is a perspective view corresponding to FIG. 5, illustrating a modification in which a pair of electrical contacts is formed at the ends of the engaging portions (engaging projections, engaging recesses) of the receptacle-side conducting members of the receptacle connector.

### DETAILED DESCRIPTION

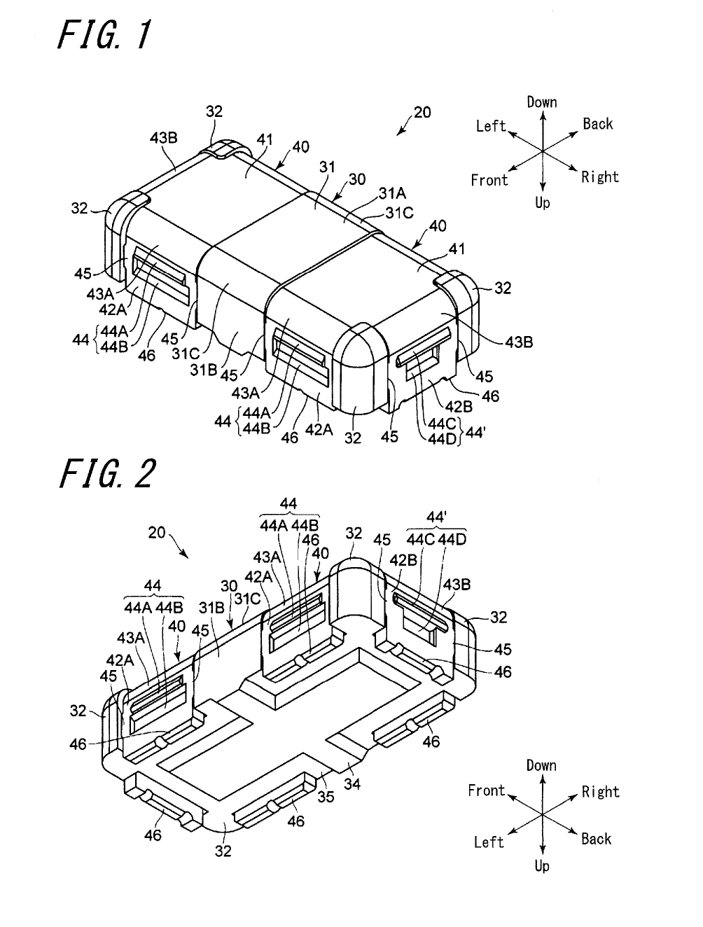

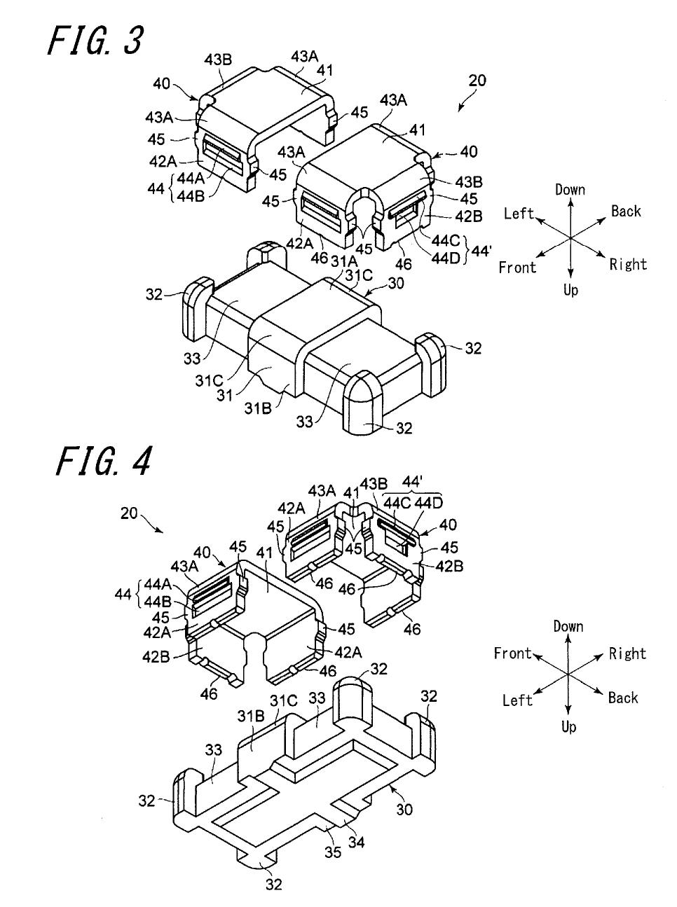

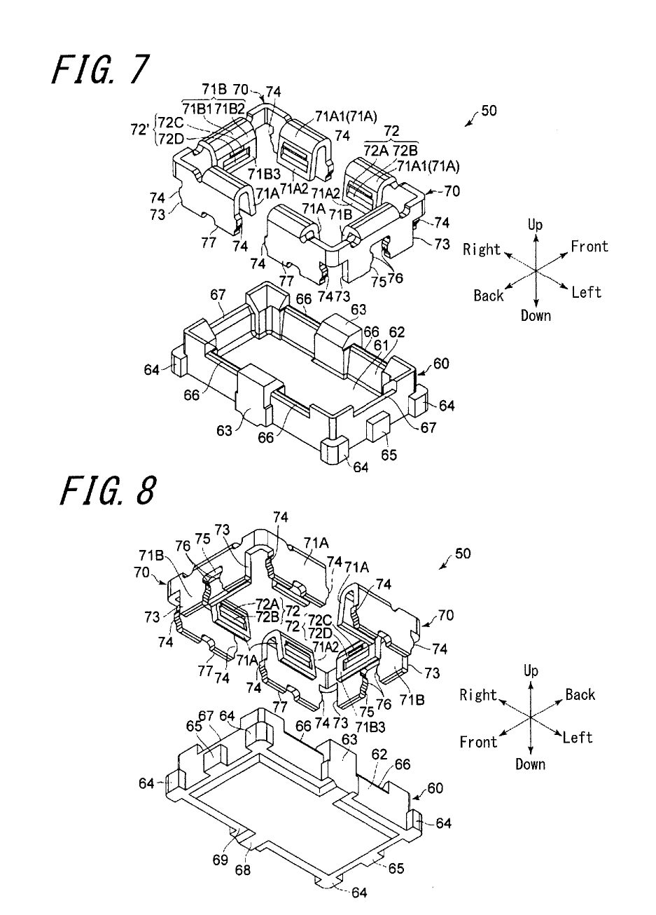

A connector system 10 of the present embodiment is described with reference to FIGS. 1 to 14. The connector system 10 is used by assembling a plug connector 20 and a receptacle connector 50 that can be fit together and separated. The directions in the following explanation (front, back, up, down, left, and right) are based on the directions of the arrows depicted in the drawings. The lower side as seen from the plug connector 20 and the upper side as seen from the receptacle connector 50 correspond to the “fitting side”, whereas the upper side as seen from the plug connector 20 and the lower side as seen from the receptacle connector 50 correspond to the “opposite side from the fitting side”.

<<Configuration of Plug Connector 20>>

FIGS. 1 to 4 illustrate the configuration of the plug connector 20. The plug connector 20 has one solid plug insulator (solid insulator) 30 and two plug-side conducting members (conducting members) 40. The two plug-side conducting members 40 have the same shape.

The solid plug insulator 30 is formed by a molding configured by an insulating synthetic resin material. The solid plug insulator 30 has a partition wall 31 positioned in the intermediate portion in the left-right direction (longitudinal direction). This partition wall 31 has an intermediate flat portion 31A facing the lower side (fitting side), two side flat portions 31B facing forward and backward, and R-shaped portions 31C connecting the intermediate flat portion 31A and the side flat portions 31B. The solid plug insulator 30 has four-corner thick portions 32, the lower side (fitting side) of which is rounded, positioned at the four corners in the front-back and left-right directions. Between the partition wall 31 and the four-corner thick portions 32, two plug-side conducting member fitting recesses (conducting member fitting recesses) 33 branched into a three-part shape are formed. A cross-shaped projection 34 that is long in the left-right direction and short in the front-back direction is formed on the upper side of the solid plug insulator 30 (on the opposite side from the fitting side). A soldering space 35 is formed around this cross-shaped projection 34.

The two plug-side conducting members 40 each have a three-part shape to fit into the two plug-side conducting member fitting recesses 33 of the solid plug insulator 30. The two plug-side conducting members 40 each have a flat portion 41 facing the lower side (fitting side). Two longitudinal opposing flat portions 42A that face forward and backward and face each other in the front-back direction are connected to the flat portion 41 via R-shaped portions 43A. A transverse flat portion 42B that faces the left or the right is connected to the flat portion 41 via an R-shaped portion 43B. The transverse flat portion 42B of each of the two plug-side conducting members 40 is an “opposing side covering portion”. Engaging portions 44, formed by an engaging projection 44A and an engaging recess 44B, are formed on the longitudinal opposing flat portion 42A. The width of the engaging projection 44A in the left-right direction is less than the width of the engaging recess 44B in the left-right direction. An engaging portion 44′, formed by an engaging projection 44C and an engaging recess 44D, is formed on the transverse flat portion 42B. The width of the engaging projection 44C in the front-back direction is greater than the width of the engaging recess 44D in the front-back direction. The width of the engaging recess 44B of the longitudinal opposing flat portion 42A in the left-right direction is greater than the width of the engaging recess 44D of the transverse flat portion 42B in the front-back direction. A pair of press-in pieces 45 is formed on the longitudinal opposing flat portion 42A and the transverse flat portion 42B. Board soldering portions 46 are formed on the upper surface of the longitudinal opposing flat portion 42A and the transverse flat portion 42B. By soldering the plug-side conducting members 40 to a plug-side board (not illustrated) via the board soldering portions 46, the plug-side board (not illustrated) is connected to the plug connector 20.

Fitting the two plug-side conducting members 40 in the two plug-side conducting member fitting recesses 33 of the solid plug insulator 30 and pressing the pairs of press-in pieces 45 of the longitudinal opposing flat portions 42A and the transverse flat portions 42B into the respective three-part shaped portions of the plug-side conducting member fitting recesses 33 completes the plug connector 20 in which the solid plug insulator 30 and two plug-side conducting members 40 are coupled.

Here, the depth of the plug-side conducting member fitting recess 33 (the depth in the up-down direction, i.e. the depth in the fitting direction, and the depth in the front-back and left-right directions, i.e. the depth in the fitting side surface directions) and the thickness of the plug-side conducting member 40 are set to be substantially equal. The curvature radius of the R-shaped portions 31C and the curvature radius of the R-shaped portions 43A and the R-shaped portion 43B are also set to be substantially equal. Consequently, the partition wall 31 (intermediate flat portion 31A, side flat portions 31B, and R-shaped portions 31C) and four-corner thick portions 32 of the solid plug insulator 30, along with the flat portions 41, longitudinal opposing flat portions 42A, transverse flat portions 42B, R-shaped portions 43A, and R-shaped portions 43B of the plug-side conducting members 40 cooperate with each other to form a “fitting projection” that has an overall smooth, flat shape (substantially flat and substantially rectangular parallelepiped shape) that is rounded at the lower side (fitting side) of the four corners in the front-back and left-right directions. In this “fitting projection”, the two plug-side conducting members 40 cover the majority (a portion) of the surface of the solid plug insulator 30.

In a state in which two plug-side conducting members 40 are fit (pressed) into one solid plug insulator 30, the side flat portions 31B of the solid plug insulator 30 and the longitudinal opposing flat portions 42A of the plug-side conducting members 40 are all aligned in the left-right direction as a substantially flat surface extending in the up-down direction.

The side flat portions 31B of the solid plug insulator 30 and the engaging projections 44A of the plug-side conducting members 40 do not project in the front-back direction (transverse direction) further than the four-corner thick portions 32. The engaging projections 44C of the plug-side conducting members 40 project further in the left-right direction (longitudinal direction) than the four-corner thick portions 32 (see FIG. 11, described below).

Focusing on the lower side (fitting side) surface of the “fitting projection”, the solid plug insulator 30 has the intermediate flat portion 31A positioned in the intermediate portion in the left-right direction (longitudinal direction). The two plug-side conducting members 40 have the flat portions (bilateral flat portions) 41 positioned so as to sandwich the intermediate flat portion 31A from both sides in the left-right direction (longitudinal direction). The intermediate flat portion 31A and the flat portions (bilateral flat portions) 41 form the “substantially flat portion” of the “fitting projection”. In terms of the below-described robustness and guiding property, the total area of the flat portions (bilateral flat portions) 41 of the two plug-side conducting members 40 in the “substantially flat portion” is preferably greater than the area of the intermediate flat portion 31A of the solid plug insulator 30.

<<Configuration of Receptacle Connector 50>>

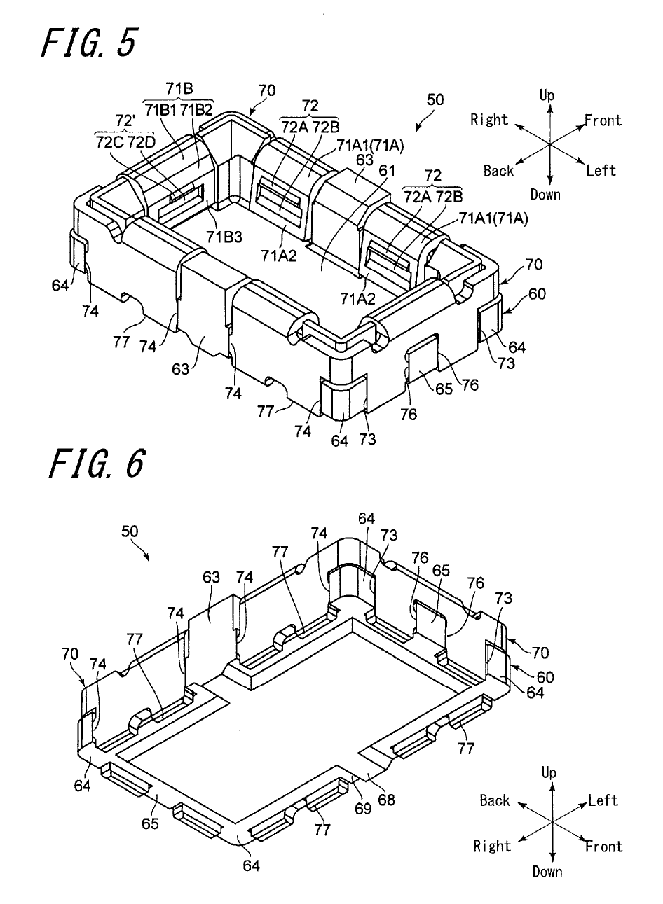

FIGS. 5 to 8 illustrate the configuration of the receptacle connector 50. The receptacle connector 50 has one receptacle insulator 60 and two receptacle-side conducting members (counterpart conducting members) 70. The two receptacle-side conducting members 70 have the same shape.

The receptacle insulator 60 is formed by a molding configured by an insulating synthetic resin material. The receptacle insulator 60 has a bottomed box-like shape having a substantially rectangular bottom 61 and rising walls 62 that rise to the upper side (fitting side) from the four sides of the bottom 61. An intermediate partition block 63 is formed at the intermediate portion in the left-right direction (longitudinal direction) of the front and back rising walls 62. Four-corner engaging blocks 64 with rounded corners are formed at the four corners in the front-back and left-right directions of the rising walls 62. An intermediate engaging block 65 is formed at the intermediate portion in the front-back direction (transverse direction) of the left and right rising walls 62. Longitudinal opposing engaging walls 66 with a height one step lower than the rising walls 62 are formed on either side of the intermediate partition block 63 of the front and back rising walls 62. A transverse engaging wall 67 with a height one step lower than the rising walls 62 is formed immediately above the intermediate engaging block 65 of the left and right rising walls 62. A cross-shaped projection 68 that is long in the left-right direction and short in the front-back direction is formed on the lower side (opposite side from the fitting side) of the receptacle insulator 60. A soldering space 69 is formed around this cross-shaped projection 68.

The two receptacle-side conducting members 70 are each substantially U-shaped for fitting onto two substantially U-shaped portions, divided by the intermediate partition blocks 63, among the rising walls 62 of the receptacle insulator 60.

The two receptacle-side conducting members 70 each have two elastic substantially inverse U-shaped engaging portions 71A that are bent inward from two facing sides of the substantially U-shape and one substantially inverse U-shaped engaging portion 71B bent inward from one side of the substantially U-shape that connects the two facing sides.

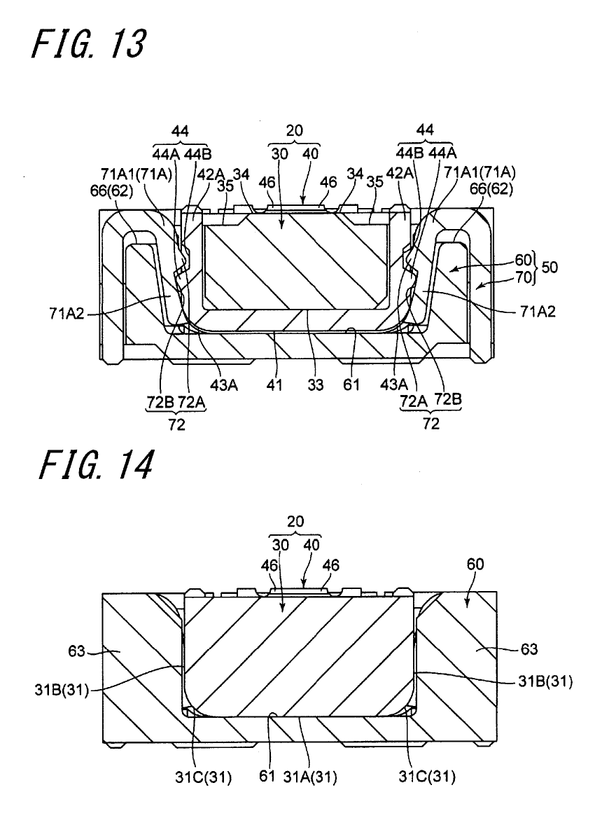

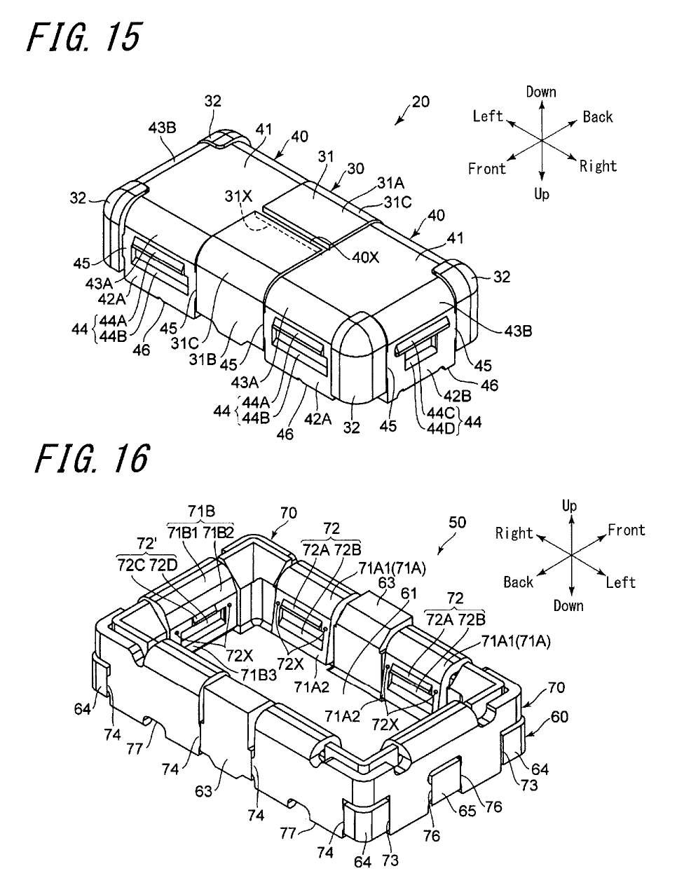

The elastic substantially inverse U-shaped engaging portions 71A are formed to elastically deform more easily than the substantially inverse U-shaped engaging portion 71B. The elastic substantially inverse U-shaped engaging portions 71A each include a bent portion 71A1 and an elastic lock portion (elastic lock surface) 71A2 extending from the bent portion 71A1. In a free state, the elastic lock portion 71A2 projects further forward or backward than the intermediate partition block 63, leaving a gap between the elastic lock portion 71A2 and the longitudinal opposing engaging wall 66 (see FIG. 5). When the elastic lock portion 71A2 elastically deforms with the bent portion 71A1 as a starting point, the elastic lock 71A2 recedes more towards the longitudinal opposing engaging wall 66 than the intermediate partition block 63 and is bent so as to face the front-back sides of the longitudinal opposing engaging wall 66 with a slight clearance (i.e. in close contact) (see FIG. 13 described below).

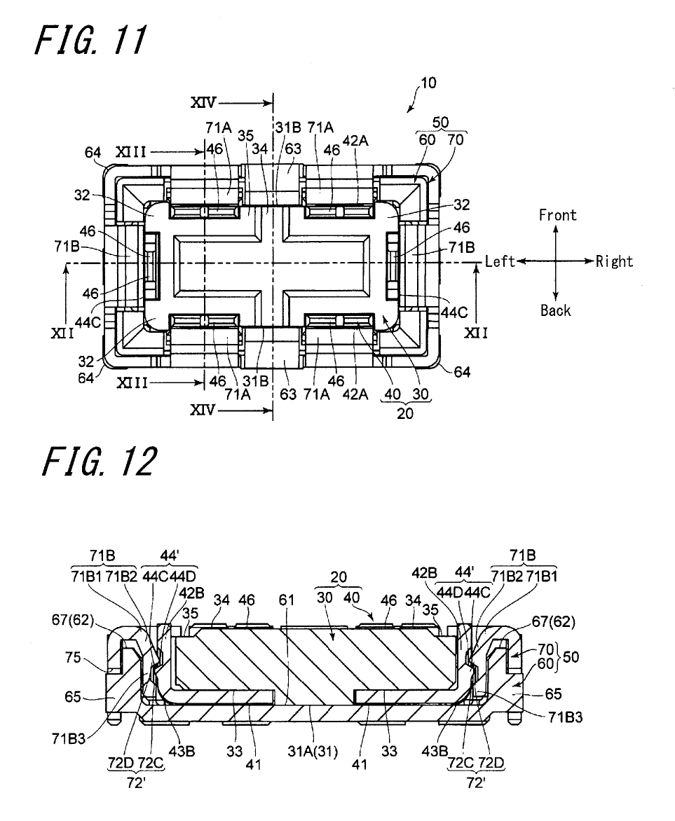

The substantially inverse U-shaped engaging portion 71B has a first bent portion 71B1, a second bent portion 71B2 extending from the first bent portion 71B1, and a lock portion (lock surface) 71B3 extending from the second bent portion 71B2. The lock portion (lock surface) 71B3 is bent inwards in two stages by the first bent portion 71B1 and the second bent portion 71B2 and faces substantially in the vertical direction (up-down direction). As a result, the lock portion (lock surface) 71B3 is bent to face both the left and right sides of the transverse engaging wall 67 with a slight clearance (i.e. in close contact) (see FIG. 12 described below).

An engaging portion 72, formed by an engaging projection 72A and an engaging recess 72B, is formed on the inner surface of the elastic substantially inverse U-shaped engaging portion 71A. An engaging portion 72′, formed by an engaging projection 72C and an engaging recess 72D, is formed on (the surface on) the fitting side of the substantially inverse U-shaped engaging portion 71B. The width of the engaging projection 72A of the elastic substantially inverse U-shaped engaging portion 71A in the left-right direction is greater than the width of the engaging projection 72C of the substantially inverse U-shaped engaging portion 71B in the front-back direction. Furthermore, the pair of engaging projections 72C are closest to each other when the pair of substantially inverse U-shaped engaging portions 71B (lock portions 71B3) that face each other in the left-right direction (longitudinal direction) is viewed. The distance between this pair of engaging projections 72C is set to be slightly smaller than the distance between the engaging projections 44C formed on the transverse flat portions 42B of the pair of plug-side conducting members 40 that face each other in the left-right direction (longitudinal direction) (see FIG. 12).

The two receptacle-side conducting members 70 each have a corner engagement hole 73 positioned at two corners of the substantially U-shape (so that the two receptacle-side conducting members 70 have a total of four corner engagement holes 73). The two receptacle-side conducting members 70 each have a pair of press-in pieces 74 positioned on the two facing sides of the substantially U-shape. The two receptacle-side conducting members 70 each have an intermediate engaging hole 75 positioned on the one side that connects the two facing sides of the substantially U-shape. A pair of press-in pieces 76 is formed on the inner surface of the intermediate engaging hole 75. Board soldering portions 77 are formed on the bottom of the substantially U-shape of the receptacle-side conducting members 70. By soldering the receptacle-side conducting members 70 to a receptacle-side board (not illustrated) via the board soldering portions 77, the receptacle-side board (not illustrated) is connected to the receptacle connector 50.

The two receptacle-side conducting members 70 are fit onto two substantially U-shaped portions, divided by the intermediate partition blocks 63, among the rising walls 62 of the receptacle insulator 60. At this time, the elastic substantially inverse U-shaped engaging portions 71A engage with the longitudinal opposing engaging walls 66, and the substantially inverse U-shaped engaging portions 71B engage with the transverse engaging walls 67. The corner engagement holes 73 engage with the four-corner engaging blocks 64, and the intermediate engaging holes 75 engage with the intermediate engaging blocks 65. Furthermore, the pair of press-in pieces 74 is pressed in between the intermediate partition block 63 and the four-corner engaging block 64, and the pair of press-in pieces 76 is pressed in by the intermediate engaging block 65. This completes the receptacle connector 50 in which the one receptacle insulator 60 and the two receptacle-side conducting members 70 are coupled.

The bottom 61 of the receptacle insulator 60, the inner surface of the four corners of the rising walls 62, and the inner surface of the intermediate partition block 63, along with the inner surfaces of the elastic substantially inverse U-shaped engaging portions 71A and the substantially inverse U-shaped engaging portions 71B of the receptacle-side conducting members 70, cooperate with each other to form a “fitting recess” that fits into the “fitting projection” of the plug connector 20. The two receptacle-side conducting members 70 do not face (are not exposed to) the bottom 61 of the “fitting recess” but rather only face (are only exposed to) the inside surface of the “fitting recess”. In plan view of the receptacle connector 50, the two receptacle-side conducting members 70 are positioned further inward than a virtual plane connecting the intermediate partition blocks 63, the four-corner engaging blocks 64, and the intermediate engaging blocks 65 of the receptacle insulator 60.

<<Configuration of Connector System 10>>

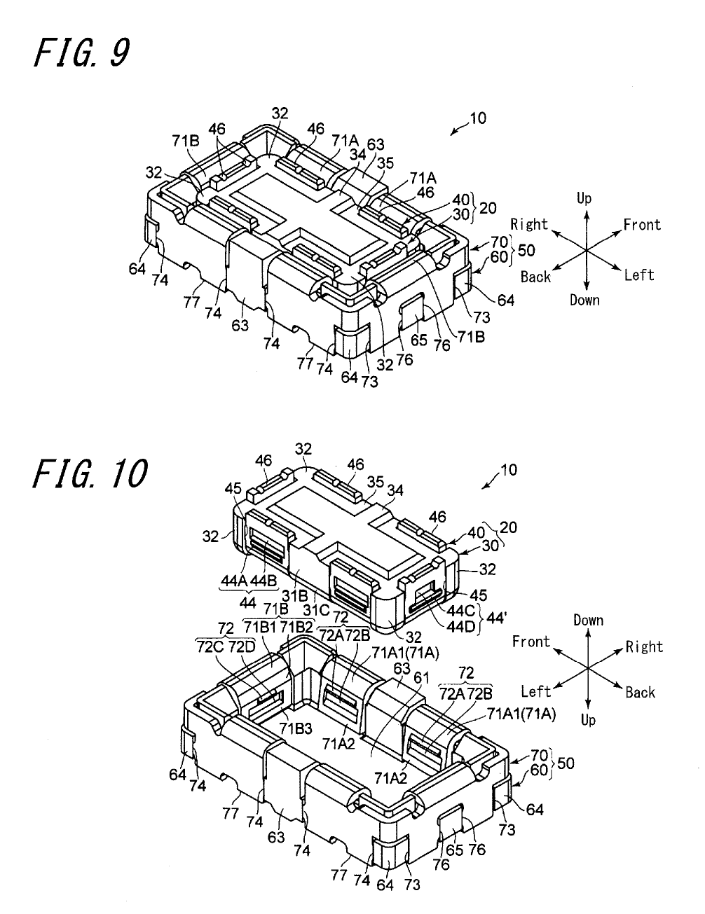

FIGS. 9 to 14 illustrate the connector system 10, which is a combination of the plug connector 20 and the receptacle connector 50. The connector system 10 is used by fitting the “fitting projection” of the plug connector 20 into the “fitting recess” of the receptacle connector 50. The “fitting projection” of the plug connector 20 has an overall smooth, flat shape (substantially flat and substantially rectangular parallelepiped shape) that is rounded at the lower side (fitting side) of the four corners in the front-back and left-right directions. Hence, the connector system 10 can be provided with a large opposing area (contact area) between the “fitting projection” of the plug connector 20 and the “fitting recess” of the receptacle connector 50. In particular, the “substantially flat portion” formed by the intermediate flat portion 31A of the solid plug insulator 30 and the flat portions (bilateral flat portions) 41 of the plug-side conducting members 40 face the “substantially flat portion” of the bottom 61 of the “fitting recess” in planar fashion with a slight clearance.

In a state in which the “fitting projection” of the plug connector 20 is fit into the “fitting recess” of the receptacle connector 50, the engaging portions 44 (engaging projections 44A, engaging recesses 44B) of the plug-side conducting members 40 and the engaging portions 72 (engaging projections 72A, engaging recesses 72B) of the receptacle-side conducting members 70 engage with each other. This engagement allows transmission of electric signals or grounding between the plug-side board (not illustrated) connected to the plug connector 20 and the receptacle-side board (not illustrated) connected to the receptacle connector 50. In other words, the plug-side conducting members 40 forming the “fitting projection” face the inside surface of the “fitting recess” and engage with the receptacle-side conducting members 70.

<<Effects of Connector System 10>>

The connector system 10 of the present embodiment is configured with the solid plug insulator 30, which has no air (space) with a low dielectric constant inside the plug insulator and is filled with resin material having a higher dielectric constant. The surface of this solid plug insulator 30 is covered by the plug-side conducting members 40. Consequently, the connector system 10 can keep the impedance of the plug-side conducting members 40 down and obtain a stable grounding capability, signaling capability, power supply capability, and the like. The connector system 10 can therefore drive a module or the like stably, without malfunction.

In the connector system 10, the plug-side conducting members 40 cover the majority of the surface of the solid plug insulator 30 (i.e. the plug-side conducting members 40 occupy a large area of the fitting projection). The impedance of the plug-side conducting members 40 can thus be further reduced.

Furthermore, when the plug connector 20 and the receptacle connector 50 are engaged, the gap between the “fitting projection” and the “fitting recess” in the connector system 10 is small (in particular, the substantially flat portion formed by the intermediate flat portion 31A of the solid plug insulator 30 and the flat portions (bilateral flat portions) 41 of the plug-side conducting members 40 face the “substantially flat portion” of the bottom 61 of the “fitting recess” in planar fashion with a slight clearance). Therefore, the connector system 10 can reduce the impedance of the plug-side conducting members 40 even more effectively.

In this way, the connector system 10 of the present embodiment can obtain stable grounding capability, signaling capability, power supply capability, and the like.

In the connector system 10 of the present embodiment, the “fitting projection” of the plug connector 20 has a rounded, smooth shape, in which the area of the plug-side conducting members 40 is greater than the area of the solid plug insulator 30 at the bottom (fitting side surface) of the plug connector 20, and in which the open portions of the elastic substantially inverse U-shaped engaging portions 71A and the substantially inverse U-shaped engaging portions 71B of the receptacle connector 50 are extended (in an open inverse U-shape). Consequently, the plug-side conducting members 40 and the receptacle-side conducting members 70 abut easily even during misaligned fitting, diagonal fitting that is inclined in plan view, or the like. Since the bottom (fitting side surface) of the plug connector 20 is a substantially flat surface, the connector system 10 can be configured so that the plug connector 20 does not catch easily on the receptacle connector 50 during insertion (in a known connector system, the plug connector and receptacle connector have a high risk of catching, since these connectors have a complex shape with spaces such as recesses, through-holes, grooves, or the like). Furthermore, in small connectors as well, the connector system 10 can inhibit resin shavings, which become a foreign object causing contact failure, and can achieve both insertibility and robustness.

In the connector system 10 of the present embodiment, the pair of engaging projections 72C are closest to each other when the pair of substantially inverse U-shaped engaging portions 71B (lock portions 71B3) that face each other in the left-right direction (longitudinal direction) is viewed. In other words, the distance between this pair of engaging projections 72C is set to be slightly smaller than the distance between the engaging projections 44C formed on the transverse flat portions 42B of the pair of plug-side conducting members 40 that face each other in the left-right direction (longitudinal direction). Consequently, when the plug connector 20 and the receptacle connector 50 are engaged, the pair of engaging projections 44C passes over the pair of engaging projections 72C in overlap for the portions to fit together (strong fitting). The connector system 10 can therefore improve the holding force upon fitting the transverse flat portions 42B of the plug-side conducting members 40 into the lock portions (lock surfaces) 71B3 of the receptacle-side conducting members 70 and improve the locking force between the engaging portions 44′ (engaging projections 44C and engaging recesses 44D) of the plug-side conducting members 40 and the engaging portions 72′ (engaging projections 72C and engaging recesses 72D) of the receptacle-side conducting members 70.

In the connector system 10 of the present embodiment, the two plug-side conducting members 40 are divided by the partition wall 31 of the solid plug insulator 30 (a clearance being provided between the two plug-side conducting members 40), and the two receptacle-side conducting members 70 are divided by the intermediate partition blocks 63 of the receptacle insulator 60 (a clearance being provided between the two receptacle-side conducting members 70). Consequently, when the two plug-side conducting members 40 are soldered to the plug-side board (not illustrated), the connector system 10 can prevent the two plug-side conducting members 40 from short-circuiting due to a solder bridge in which adjacent solder portions short-circuit (insulation properties of the two plug-side conducting members 40 can be obtained). When the two receptacle-side conducting members 70 are soldered to the receptacle-side board (not illustrated), the connector system 10 can prevent the two receptacle-side conducting members 70 from short-circuiting due to a solder bridge in which adjacent solder portions short-circuit (insulation properties of the two receptacle-side conducting members 70 can be obtained).

In the connector system 10 of the present embodiment, a plug insulator is configured as the solid plug insulator 30, which does not have multi-pole contacts therein, i.e. in which a recess, through-hole, groove, or the like for housing (embedding) multi-pole contacts is not formed. In particular, the solid plug insulator 30 does not contain a gap between the transverse flat portions 42B (opposing side covering portions) of the two plug-side conducting members 40. Moreover, the plug-side conducting member of the connector system 10 is configured by the two plug-side conducting members 40 that cover the majority of the surface of the solid plug insulator 30. The connector system 10 therefore has increased robustness to prevent damage or crushing, while responding to the demand for size reduction, and moreover can be produced easily because of the small number of components.

The connector system 10 of the present embodiment achieves double engagement when the “fitting projection” of the plug connector 20 is fit into the “fitting recess” of the receptacle connector 50: engagement between the engaging projections 44A of the plug-side conducting members 40 and the engaging recesses 72B of the receptacle-side conducting members 70, and engagement between the engaging recesses 44B of the plug-side conducting members 40 and the engaging projections 72A of the receptacle-side conducting members 70. The connector system 10 can thereby improve the holding force upon fitting of the plug connector 20 and the receptacle connector 50. The connector system 10 can establish a large opposing area (contact area) between the “fitting projection” of the plug connector 20 and the “fitting recess” of the receptacle connector 50 to disperse and receive the force acting between these two portions. The connector system 10 can thus increase the fitting stability of these portions. The connector system 10 can also obtain both the locking effect and contact (conduction) effect of the plug-side conducting members 40 and the receptacle-side conducting members 70.

In the connector system 10 of the present embodiment, the intermediate flat portion 31A of the solid plug insulator 30 and the flat portions (bilateral flat portions) 41 of the plug-side conducting members 40 form a “substantially flat portion”, and the bottom 61 of the “fitting recess” forms a “substantially flat portion”. These “substantially flat portions” in the connector system 10 can therefore be formed as a suction surface by suction means such as a suction pad. In this way, the connector system 10 allows easy suction conveyance in the manufacturing line (suction is reliable since the suction surface is flat, despite being small).

In the connector system 10 of the present embodiment, the solid plug insulator 30 has the cross-shaped projection 34 as the contact surface with the plug-side board (not illustrated), and the receptacle insulator 60 has the cross-shaped projection 68 as the contact surface with the receptacle-side board (not illustrated). Consequently, the robustness of the connector system 10 (plug connector 20 and receptacle connector 50) improves, and if an external force acts on the plug connector 20 and the receptacle connector 50 at the time of fitting, the cross-shaped projection 34 and the cross-shaped projection 68 can mitigate the impact from the external force. At the time of soldering, the connector system 10 can also prevent melted solder from contacting the solid plug insulator 30 and the receptacle insulator 60.

The connector system 10 of the present embodiment is configured so that in plan view of the receptacle connector 50, the two receptacle-side conducting members 70 are positioned further inward than a virtual plane connecting the intermediate partition blocks 63, the four-corner engaging blocks 64, and the intermediate engaging blocks 65 of the receptacle insulator 60. The connector system 10 can therefore prevent damage for reasons such as the receptacle-side conducting members 70 being impacted during conveyance of the receptacle connector 50 or the connector system 10.

In the connector system 10 of the present embodiment, the four-corner thick portions 32 of the solid plug insulator 30 project further in the front-back direction (transverse direction) than the side flat portions 31B of the solid plug insulator 30 and the engaging projections 44A of the plug-side conducting members 40 (see FIG. 11). The connector system 10 can therefore prevent damage for reasons such as the plug-side conducting members 40 being impacted during conveyance of the plug connector 20 or the connector system 10.

The connector system 10 of the present embodiment can prevent board peeling (solder peeling), since the two plug-side conducting members 40 and the plug-side board (not illustrated) are connected at six locations (board soldering portions 46) and the two receptacle-side conducting members 70 and the receptacle-side board (not illustrated) are connected at six locations (board soldering portions 77).

<<Modification to Connector System 10>>

In the connector system 10, the number of plug-side conducting members 40 of the plug connector 20 may be changed from two (two-pin) to one (one-pin). For example, as illustrated in FIG. 15, the connector system 10 may be configured by forming a communicating groove 31X that extends in the left-right direction in the partition wall 31 of the solid plug insulator 30 and providing a conducting connector 40X in this communicating groove 31X to connect and unite the two plug-side conducting members 40.

As illustrated in FIG. 16, the connector system 10 may be configured by forming a pair of electrical contacts 72X on either side of the engaging portions 72 (engaging projections 72A, engaging recesses 72B) of the receptacle-side conducting members 70 in the receptacle connector 50. The connector system 10 can thus improve the contact (conduction) stability between the plug-side conducting members 40 and the receptacle-side conducting members 70.

A minute recess small enough to be considered a “substantially flat portion” may be provided in the intermediate flat portion 31A of the partition wall 31 of the solid plug insulator 30 in the connector system 10.

The connector system 10 may have improved conductivity of electricity by including gold plating on the plug-side conducting members 40 and the receptacle-side conducting members 70. The location that is gold plated may be selected freely. For example, gold plating may be applied to the fitting surface side of the plug-side conducting members 40 and/or to a pair of engaging portions 72 (engaging projections 72A, engaging recesses 72B) separated in the left-right direction (longitudinal direction) of the receptacle-side conducting members 70.

The solid plug insulator 30 and the two plug-side conducting members 40 and/or the one receptacle insulator 60 and the two receptacle-side conducting members 70 need not be integrated by being pressed together and may, for example, be formed as an integral molded article by insert molding.

In the above embodiment, an example of the receptacle-side conducting members 70 not facing the bottom 61 of the “fitting recess” but rather only facing the inside surface of the “fitting recess” has been described. The receptacle-side conducting members 70 may, however, face only the bottom 61 of the “fitting recess” or may face both the bottom 61 of the “fitting recess” and the inside surface of the “fitting recess”.

20

### REFERENCE SIGNS LIST

10 Connector system

20 Plug connector (connector)

30 Solid plug insulator (solid insulator)

31 Partition wall (fitting projection)

31A Intermediate flat portion (fitting projection, substantially flat portion)

31B Side flat portion (fitting projection)

31C R-shaped portion (fitting projection)

31X Communicating groove

32 Four-corner thick portion (fitting projection)

33 Plug-side conducting member fitting recess (conducting member fitting recess)

34 Cross-shaped projection

35 Soldering space

40 Plug-side conducting member (conducting member)

40X Conducting connector

41 Flat portion (fitting projection, bilateral flat portion, substantially flat portion)

42A Longitudinal opposing flat portion (fitting projection)

42B Transverse flat portion (fitting projection, opposing side covering portion)

43A R-shaped portion (fitting projection)

43B R-shaped portion (fitting projection)

44 Engaging portion

44A Engaging projection

44B Engaging recess

44′ Engaging portion

44C Engaging projection

44D Engaging recess

45 Press-in piece

46 Board soldering portion

50 Receptacle connector (counterpart connector)

60 Receptacle insulator

61 Bottom (fitting recess, substantially flat portion)

62 Rising wall (fitting recess)

63 Intermediate partition block (fitting recess)

64 Four-corner engaging block

65 Intermediate engaging block

66 Longitudinal opposing engaging wall

67 Transverse engaging wall

68 Cross-shaped projection

69 Soldering space

70 Receptacle-side conducting member (counterpart conducting member)

71A Elastic substantially inverse U-shaped engaging portion (fitting recess)

71A1 Bent portion

71A2 Elastic lock portion (elastic lock surface)

71B Substantially inverse U-shaped engaging portion (fitting recess)

71B1 First bent portion

71B2 Second bent portion

71B3 Lock portion (lock surface)

72 Engaging portion

72A Engaging projection

72B Engaging recess

72′ Engaging portion

72C Engaging projection

72D Engaging recess

72X Electrical contact

73 Corner engagement hole

74 Press-in piece

75 Intermediate engaging hole

76 Press-in piece

77 Board soldering portion

1. A connector comprising:
an insulator filled with resin; and
one or two conducting members covering a portion of a surface of said insulator; wherein
said insulator and said conducting members cooperate with each other to form a fitting projection that fits into a fitting recess of a counterpart connector.

2. The connector of claim 1, wherein said fitting projection comprises a substantially flat portion facing a bottom of said fitting recess.

3. The connector of claim 2, wherein said insulator comprises an intermediate flat portion positioned in an intermediate portion in a longitudinal direction;
said conducting members comprise bilateral flat portions positioned so as to sandwich said intermediate flat portion from both sides in said longitudinal direction; and
said intermediate flat portion and said bilateral flat portions form said substantially flat portion of said fitting projection.

4. The connector of claim 2, wherein the bottom of said fitting recess is formed by a substantially flat portion that faces said substantially flat portion of said fitting projection with a slight clearance.

5. The connector of claim 1, wherein
said counterpart connector comprises a counterpart conducting member facing an inside surface of said fitting recess, and
said conducting members forming said fitting projection are configured to face the inside surface of said fitting recess and to engage with said counterpart conducting member.

6. The connector of claim 1, wherein
said insulator and said connector comprising said conducting members have a substantially rectangular parallelepiped shape,
said conducting members comprise opposing side covering portions covering opposing sides of said insulator that are separated in a longitudinal direction of said substantially rectangular parallelepiped shape, and
said insulator does not have a gap between said opposing side covering portions of said conducting members.

7. A connector system comprising a plug connector and a receptacle connector used by being assembled together, wherein
said plug connector comprises an insulator filled with resin and one or two conducting members covering a portion of a surface of said insulator; and
said insulator and said conducting members cooperate with each other to form a fitting projection that fits into a fitting recess of said receptacle connector.
